(19) United States
(12) Patent Application Publication
(10) Pub. No.: US 2019/0352137 A1
(43) Pub. Date: Nov. 21, 2019

(54) ELEVATOR DOOR SILL WITH SELF-CLEANING DEVICE

(71) Applicant: Otis Elevator Company, Farmington, CT (US)

(72) Inventors: Fanping Sun, Glastonbury, CT (US); Walter Thomas Schmidt, Marlborough, CT (US); Enrico Manes, Feeding Hills, MA (US)

(21) Appl. No.: 15/983,908

(22) Filed: May 18, 2018

(51) Int. Cl. B66B 13/30; B08B 5/02

(52) U.S. Cl. CPC B66B 13/301; B08B 5/02

(57) ABSTRACT

A cleaning system for cleaning a door sill of an elevator includes at least one nozzle mounted within the door sill. An outlet of the at least one nozzle directed into a sill cavity formed in the door sill. An air supply arranged in fluid communication with the at least one nozzle. Air from the air supply is selectively provided to the at least one nozzle to remove debris from sill cavity.

### BACKGROUND

Embodiments of the disclosure relate to elevator systems having one or more slidable doors suspended above a door sill, and more particularly, to a cleaning device for removing dirt and debris from the door sill of the elevator system.

A typical elevator system employs sliding hoistway or landing doors and sliding car doors that are suspended from overhead. In order to prevent the bottom of the doors from swinging into or away from the hoistway (or into and out of the elevator car), while at the same time allowing the doors to slide between an opened and closed position, one or more door guides are fastened to a lower portion of the door. Traditionally, these door guides are received in an upward facing slot formed in a door sill. The guides have a shape complementary to the slot. This engagement between the door guides and the slot defines a path of movement of the door between an open and closed position, while preventing the bottom of the door from swinging in a direction perpendicular to the sliding motion of the door.

Litter and debris often falls or is pushed into the upward facing slot formed in the door sill and impede proper operation of the door. To address this problem, a cleaning brush is sometimes attached to the lower end of the door. As the doors slide relative to the sill, the brush sweeps debris within the sill. However, inclusion of such brushing devices have proven to be insufficient for cleaning the slot to prevent door jamming and door movement jittering. Accordingly, there is a need for a device capable of deep-cleaning the door sill to prevent dust and debris from accumulating within the slot formed in the sill.

### BRIEF DESCRIPTION

According to an embodiment, a cleaning system for cleaning a door sill of an elevator includes at least one nozzle mounted within the door sill. An outlet of the at least one nozzle directed into a sill cavity formed in the door sill. An air supply arranged in fluid communication with the at least one nozzle. Air from the air supply is selectively provided to the at least one nozzle to remove debris from sill cavity.

In addition to one or more of the features described above, or as an alternative, in further embodiments the at least one nozzle is oriented parallel to a path of sliding movement defined by the sill cavity.

In addition to one or more of the features described above, or as an alternative, in further embodiments the at least one nozzle is oriented at an angle to a path of sliding movement defined by the sill cavity.

In addition to one or more of the features described above, or as an alternative, in further embodiments comprising at least one opening formed in a lower surface of the sill cavity.

In addition to one or more of the features described above, or as an alternative, in further embodiments the at least one nozzle is oriented toward the at least one opening to force debris within the sill cavity through the at least one opening.

In addition to one or more of the features described above, or as an alternative, in further embodiments the air supply is selectively provided to the at least one nozzle at a predetermined interval.

In addition to one or more of the features described above, or as an alternative, in further embodiments the air supply is selectively provided to the at least one nozzle in response to a predefined event.

In addition to one or more of the features described above, or as an alternative, in further embodiments comprising a sensor for measuring debris accumulation within the sill cavity, wherein the air supply is selectively provided to the at least one nozzle in response to a signal generated by the sensor.

In addition to one or more of the features described above, or as an alternative, in further embodiments the air supply includes a bellow pump.

In addition to one or more of the features described above, or as an alternative, in further embodiments the cleaning system further comprises an air storage tank for receiving pressurized air from the air supply, the air storage tank being arranged in fluid communication with the at least one nozzle.

In addition to one or more of the features described above, or as an alternative, in further embodiments the cleaning system further comprises at least one valve disposed between the air supply and the at least one nozzle, the at least one valve being operable to selectively provide air from the air supply to the at least one nozzle.

According to another embodiment, an elevator system includes a hoistway having a plurality of landings, each of the plurality of landings having a landing door associated with a landing door sill. An elevator car is disposed within the hoistway and is movable between the plurality of landings. The elevator car has an elevator car door associated with a car door sill. At least one cleaning system is disposed in fluid communication with a sill cavity formed in at least one of the car door sill and the landing door sill. The cleaning system is automatically operable to move debris accumulated within the sill cavity of at least one of the car door sill and the landing door sill into the hoistway.

In addition to one or more of the features described above, or as an alternative, in further embodiments the at least one cleaning system is disposed within the hoistway and is associated with one of the plurality of landings.

In addition to one or more of the features described above, or as an alternative, in further embodiments the at least one cleaning system is operable to remove debris from the car door sill and the landing door sill simultaneously.

In addition to one or more of the features described above, or as an alternative, in further embodiments the at least one cleaning system includes a plurality of cleaning systems, each of the plurality of cleaning systems being disposed at a distinct location throughout the hoistway.

According to another embodiment, a method of cleaning a door sill or an elevator includes providing at least one nozzle, the at least one nozzle being mounted such that an outlet of the nozzle is directed into a sill cavity formed in the door sill, providing an air supply in fluid communication with the at least one nozzle, and automatically supplying air from the air supply to the at least one nozzle to remove debris from the sill cavity.

In addition to one or more of the features described above, or as an alternative, in further embodiments removing debris from the sill cavity further comprises forcing the debris through one or more openings formed in the sill cavity into a hoistway of the elevator.

In addition to one or more of the features described above, or as an alternative, in further embodiments automatically supplying air from the air supply to the at least one nozzle occurs at a predetermined interval.

In addition to one or more of the features described above, or as an alternative, in further embodiments automatically supplying air from the air supply to the at least one nozzle occurs in response to a predefined event.

In addition to one or more of the features described above, or as an alternative, in further embodiments automatically supplying air from the air supply to the at least one nozzle occurs in response to detection of an accumulation of debris within the sill cavity.

### BRIEF DESCRIPTION OF THE DRAWINGS

The following descriptions should not be considered limiting in any way. With reference to the accompanying drawings, like elements are numbered alike:

FIG. 1 is a front view of a portion of an elevator system;

FIG. 2 is a plan view of an elevator system when the elevator car is parked at a landing;

FIG. 3 is a cross-sectional view of a door assembly according to an embodiment;

FIG. 4 is a cross-sectional view of a door assembly including a sill cleaning system according to an embodiment; and

FIG. 5 is a front view of a door assembly including a sill cleaning system according to an embodiment; and

FIG. 6 is a front view of a door assembly including a sill cleaning system according to another embodiment.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

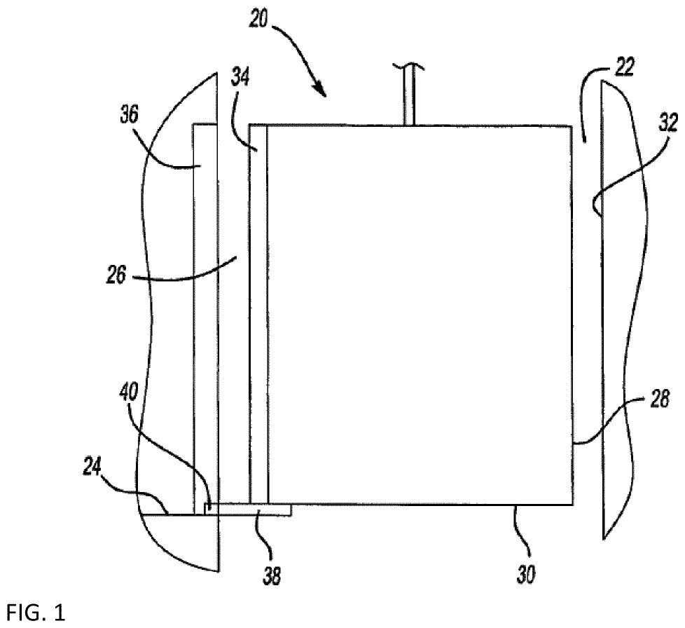

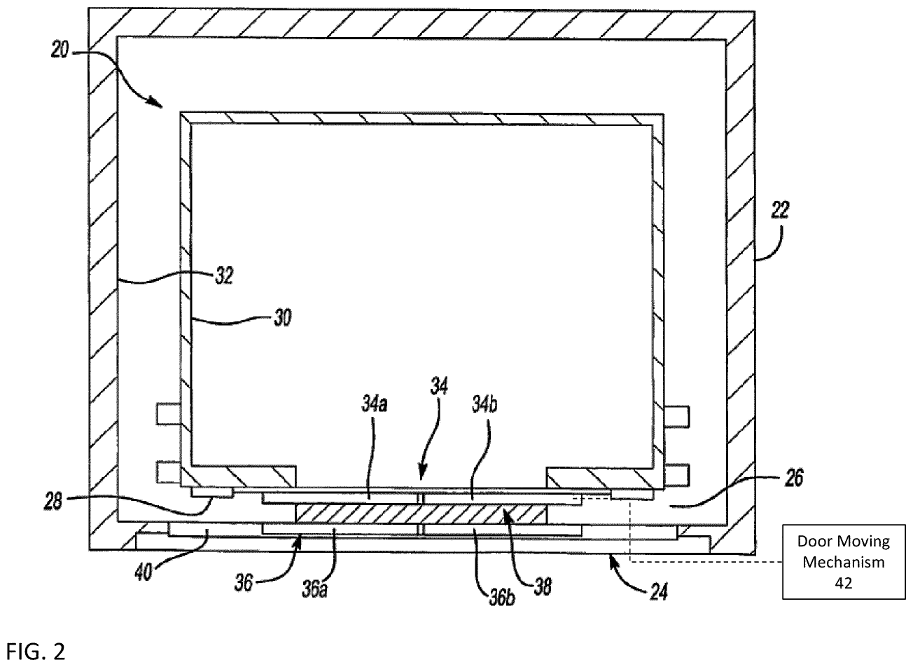

With reference now to FIGS. 1 and 2, an example of an elevator system 20 including an elevator car 30 mounted within a hoistway 22 for vertical movement between a plurality of landings 24 is illustrated. An operating gap 26 is maintained between an exterior surface 28 of the elevator car 30 and the walls 32 of the hoistway 32. The operating gap is sized to provide a sufficient running clearance between the hoistway walls 32 and the elevator car 30 as the car 30 moves between landings 24 within the hoistway.

The elevator car 30 includes an elevator door assembly 34 that moves between open and closed positions. When the elevator car 30 stops at one of the plurality of landings 24, the elevator door assembly 34 is aligned with a corresponding landing door assembly 36. A sill 38 of the elevator car 30 extends outwards from the car 30 toward the landing door assembly 36 to bridge the operating gap 26 between the elevator door assembly 34 and the landing 24. In the illustrated, non-limiting embodiment, the sill 38 extends out from underneath the elevator door assembly 34 and engages a landing structure, such as the landing sill 40 for example. The sill 38 may include a plate member that provides a continuous, unbroken surface such that there are no gaps between the elevator door assembly 34 and the landing door assembly 36.

In the illustrated, non-limiting embodiment of FIG. 2, the elevator door assembly 34 includes a first door 34a and a second door 34b, supported on a track (not shown) for movement relative to the elevator car 30 between an open and closed position. Similarly, the landing door assembly 36 includes a first door 36a and a second door 36b that are supported for movement relative to a landing door frame structure. A door moving mechanism, illustrated schematically at 42, includes an interlock to open and close the car and landing doors 34a, 34b, 36ta, 36b in unison when the elevator car 30 is parked at a landing. Any type of door moving mechanism 42 and interlock as known in the art could be used. Further, the operation of door moving mechanisms and interlocks are well known and will not be discussed in detail. Although the illustrated door assemblies 34, 36, include two doors that transform between a closed position and an open position by moving in opposite directions, other door configurations, such as a single door, or alternatively, telescoping doors are also within the scope of the disclosure.

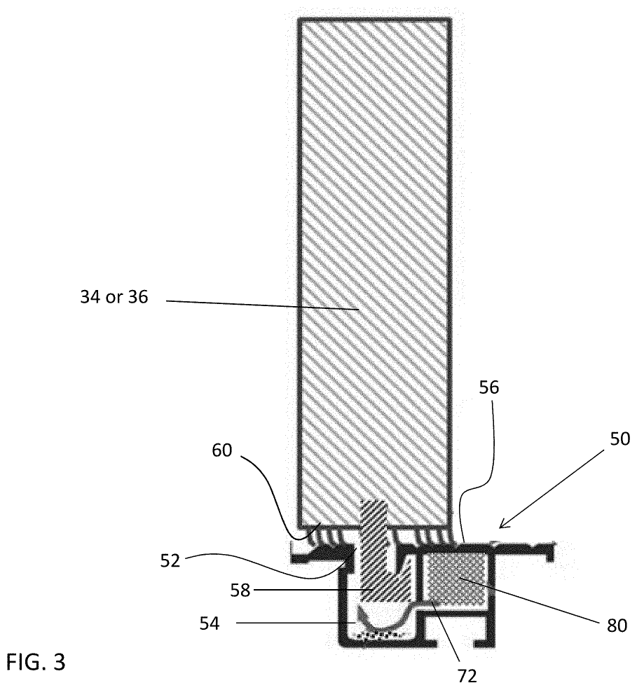

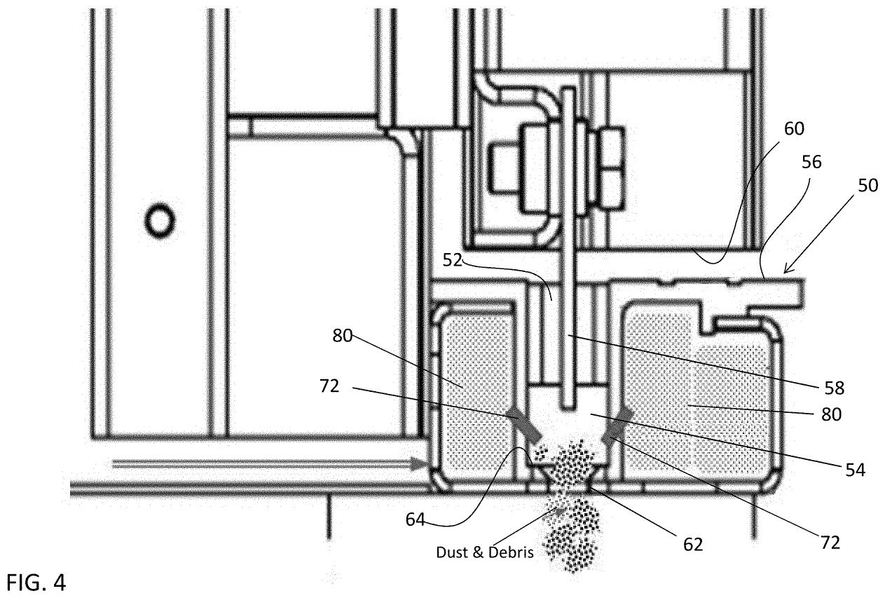

With reference now to FIGS. 3-4, an example of a door sill 50, such as either the car door sill or the landing door sill, is illustrated in more detail. As shown, the door sill 50 is typically formed from a metal or metal alloy, such as by bending a piece of sheet metal or via an extrusion process for example. The sill 50 has one or more slots 52 formed therein which define a sill cavity 54. In the illustrated, non-limiting embodiment, the slots 52 are formed in an upper surface 56 of the sill 50 and extend generally vertically downward through the majority of the height of the sill 50. Each slot 52 formed in the sill 50 may be associated with a corresponding door, such as landing door 36a or landing door 36b for example. For example, one or more door guides or gibs 58 extending from a bottom surface 60 of each door 36 may be received within the slot 52 and sill cavity 54. The door guide 58 is sized relative to the slot 52 to limit movement of the door in a direction perpendicular to the path of sliding movement. As a result, each slot 52 has a length generally equal to the path of sliding movement of the door 36 associated therewith between an open and closed position.

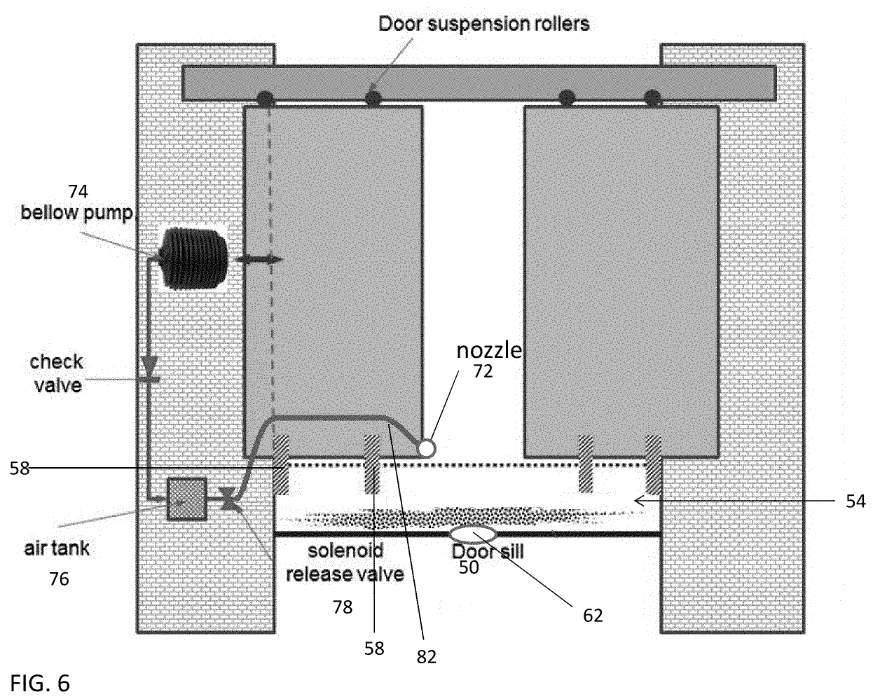

Further, as best shown in FIG. 4, one or more through holes or openings 62 may be formed in the surface 64 of the sill 50 at the bottom of the sill cavity 54. These openings 62 may be sized to allow particulate matter and small pieces of debris to pass from the sill cavity 54 and into the hoistway 22 or an adjacent area (not shown) for collection during a maintenance operation. In embodiments including only a single opening, such as shown in FIG. 6 for example, the single opening may be located at a center of the sill cavity 54 and is typically larger than embodiments having a plurality of smaller openings 62.

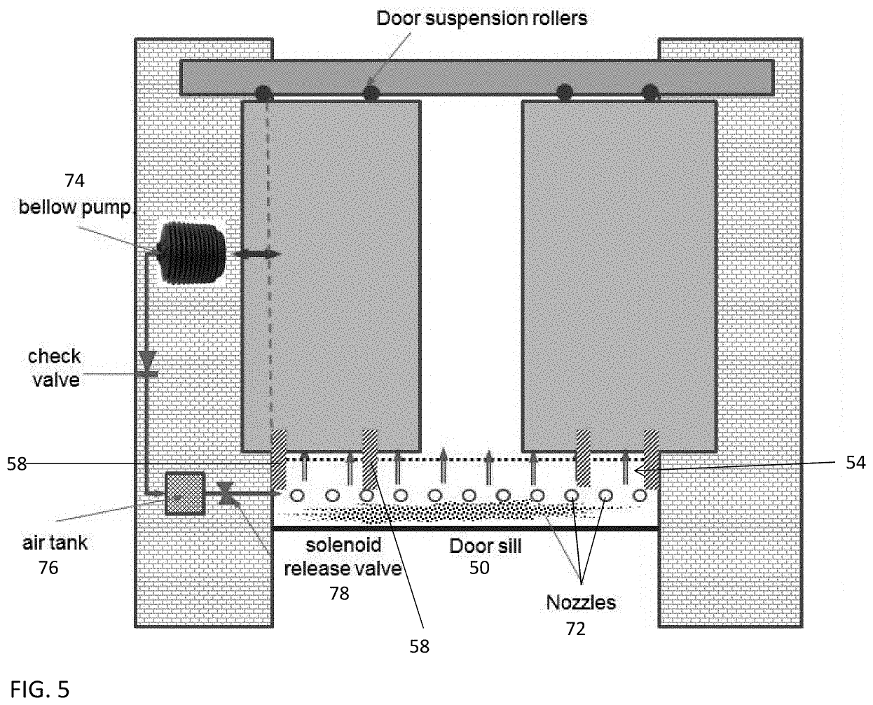

The elevator system 20 may further includes a mechanism or system 70 for removing dirt and/or debris from a door sill. With continued reference to FIGS. 3 and 4, and additional reference now to FIGS. 5 and 6, an example of a sill cleaning system 70 for cleaning an elevator door sill 50, such as either the car door sill 38 and/or the landing door sill 40 for example, is illustrated in more detail. Although a single cleaning system 70 is illustrated adjacent a landing 24, it should be understood that embodiments having multiple cleaning systems 70 associated with a landing 24 are also within the scope of the disclosure. In such embodiments, the plurality of cleaning systems 70 may be operable to clean the same sill 50, or alternatively, different sills 50, such as the landing door sill 40 and the elevator car door sill 28, when the elevator car is parked at the landing 24.

As shown, the cleaning system 70 includes one or more nozzles 72 arranged in fluid communication with the sill cavity 54. The nozzles 72 are operably coupled to a source of compressed air 74. In the illustrated, non-limiting embodiment of FIG. 3, the source of compressed air 74 includes a bellow pump configured to deliver air to a separate air tank 76 under pressure. A valve 78, such as a solenoid release valve for example, may be disposed within the fluid pathway between the storage air tank 76 and the one or more nozzles 72. The valve 78 is selectively operable to control a flow of air from the tank 76 to the plurality of nozzles 72. However, other system configurations, such as where the at least one nozzle 72 is directly connected to the source of pressurized air 74, such as a canister of compressed air or an air pump for example, are also within the scope of the disclosure.

In an embodiment, the nozzles 72 may be mounted within a manifold 80 formed in the sill 50, adjacent at least one side of the sill cavity 54. In some embodiments, the nozzles 72 may be mounted adjacent opposing sides of the sill cavity 54. The air supplied by the nozzles 72 may be sufficient to force the dirt and debris within the sill cavity 54 through the openings 62. Alternatively, the air may be provided in conjunction with the sliding movement of the door guides 58 such that the cleaning system 70 cooperates with the doors to facilitate removal or debris from the sill cavity 54. In such embodiments, the nozzles 72 may be mounted within the manifold 80, or alternatively or in addition, may be mounted within a portion of the sliding door 34 or 36. If the nozzles 72 are disposed within the door 34 or 36, the nozzles 72 are coupled to the air tank 76 via a flexible conduit or tube 82.

Accordingly, regardless of whether the nozzles 72 are mounted to the manifold 80 or to the door 34 or 36, various orientations of the nozzles 72 relative to the sill cavity 54 are within the scope of the disclosure. For example, in an embodiment, the nozzles 72 may be oriented to supply a flow of air that moves generally parallel to the path of sliding movement defined by the sill cavity 54, i.e. a generally horizontal air flow. Alternatively, the nozzles 72 may be oriented vertically, or at an upward angle, to loosen and lift debris and dust or dirt particles off of the lower surface 64 of the sill cavity 54. In yet another embodiment, the nozzles 72 may be angled downwardly toward the lower surface 64 of the sill cavity 54 and/or toward the one or more openings 62 formed in the lower surface 64. Further in embodiments including a plurality of nozzles 72, the plurality of nozzles 72 may have the same, or may have different orientations relative to the sill cavity 54. It should be understood that a nozzle 74 having any orientation suitable to loosen or eliminate dirt and debris from the sill cavity 54 is contemplated herein.

The elevator system 20 may include one or more sill cleaning systems 70. For example, in an embodiment, each a sill cleaning system 70 may be associated with each of the plurality of landings 24 of the elevator system 20. In other embodiments, only a portion of the landings 24, such as the landings that experience the highest volume of traffic for example, may be associated with a cleaning system 70. Further, a portion of the sill cleaning system associated with a landing may be disposed within the hoistway. As best shown in FIG. 5, at least one of the air pump 74, the air storage tank 76, and a valve 78 may be mounted within the interior of the hoistway 22, at a position that does not interfere with the path of movement of the elevator car 30. The components of the cleaning system 70 mounted within the hoistway 22 may be disposed in fluid communication with the plurality of nozzles 72 mounted at the landing sill 40 of the corresponding landing 24. Alternatively, or in addition, the components of the cleaning system 70 mounted within the hoistway 22 may be arranged in fluid communication with the plurality of nozzles associated with the elevator car door sill 38 when the elevator car 30 is parked at the landing. As a result, air from the cleaning system 70 may be used to clean one or both of the landing door sill 40 and the elevator car door sill 38.

Each cleaning system 70 of the elevator system 20 may be selectively operated by supplying air to the nozzles to clean one or more door sills 50. In an embodiment, operation of the cleaning system 70 occurs at scheduled intervals, such as once a day for example. Alternatively, operation of the cleaning system 70 may occur automatically, such as in response to a predetermined event, for example an elevator car parking at a landing associated with the cleaning system 70. The cleaning system 70 may supply air to a door sill 50 while the car 30 is parked at the landing 24, or alternatively, after the car 30 has moved from the landing 24. In yet another embodiment, the cleaning system 70 is operable in response to a signal indicating that the door sill 50 needs to be cleaned. For example, a sensor (not shown) associated with the landing door sill 50 and operable to detect an accumulation of debris or dirt within the sill 50 may be arranged in communication with the air pump 74 and/or the valve 78. Initiation of operation of the cleaning system 70, as described herein, is intended as an example only, it should be understood that any suitable trigger for initiating operation of the cleaning system 70 is within the scope of the disclosure. Further, maintenance personnel may have access to the cleaning system 70 such that the system can be activated at any time during a maintenance visit.

The cleaning system 70 illustrated and described herein actively blows the dust and debris through the plurality of openings 62 into the hoistway 22, thereby reducing or eliminating the need for custodial cleaning of the door sills, and eliminating most of the issues, such as jamming an unsmooth operation caused by the accumulation of debris. Further, the cleaning system 70 requires minimal maintenance and no external power for operation.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A cleaning system for cleaning a door sill of an elevator, comprising:
at least one nozzle mounted within the door sill, an outlet of the at least one nozzle directed into a sill cavity formed in the door sill; and
an air supply arranged in fluid communication with the at least one nozzle, wherein air from the air supply is selectively provided to the at least one nozzle to remove debris from sill cavity.

2. The cleaning system of claim 1, wherein the at least one nozzle is oriented parallel to a path of sliding movement defined by the sill cavity.

3. The cleaning system of claim 1, wherein the at least one nozzle is oriented at an angle to a path of sliding movement defined by the sill cavity.

4. The cleaning system of claim 1, further comprising at least one opening formed in a lower surface of the sill cavity.

5. The cleaning system of claim 4, wherein the at least one nozzle is oriented toward the at least one opening to force debris within the sill cavity through the at least one opening.

6. The cleaning system of claim 1, wherein the air supply is selectively provided to the at least one nozzle at a predetermined interval.

7. The cleaning system of claim 1, wherein the air supply is selectively provided to the at least one nozzle in response to a predefined event.

8. The cleaning system of claim 1, further comprising a sensor for measuring debris accumulation within the sill cavity, wherein the air supply is selectively provided to the at least one nozzle in response to a signal generated by the sensor.

9. The cleaning system of claim 1, wherein the air supply includes a bellow pump.

10. The cleaning system of claim 1, wherein the cleaning system further comprises an air storage tank for receiving pressurized air from the air supply, the air storage tank being arranged in fluid communication with the at least one nozzle.

11. The cleaning system of claim 1, wherein the cleaning system further comprises at least one valve disposed between the air supply and the at least one nozzle, the at least one valve being operable to selectively provide air from the air supply to the at least one nozzle.

12. An elevator system comprising:
a hoistway having a plurality of landings, each of the plurality of landings having a landing door associated with a landing door sill;
an elevator car disposed within the hoistway and movable between the plurality of landings, the elevator car having an elevator car door associated with a car door sill; and
at least one cleaning system disposed in fluid communication with a sill cavity formed in at least one of the car door sill and the landing door sill, the cleaning system being automatically operable to move debris accumulated within the sill cavity of at least one of the car door sill and the landing door sill into the hoistway.

13. The elevator system of claim 12, wherein the at least one cleaning system is disposed within the hoistway and is associated with one of the plurality of landings.

14. The elevator system of claim 12, wherein the at least one cleaning system is operable to remove debris from the car door sill and the landing door sill simultaneously.

15. The elevator system of claim 12, wherein the at least one cleaning system includes a plurality of cleaning systems, each of the plurality of cleaning systems being disposed at a distinct location throughout the hoistway.

16. A method of cleaning a door sill or an elevator comprising:
providing at least one nozzle, the at least one nozzle being mounted such that an outlet of the nozzle is directed into a sill cavity formed in the door sill;
providing an air supply in fluid communication with the at least one nozzle; and
automatically supplying air from the air supply to the at least one nozzle to remove debris from the sill cavity.

17. The method of claim 16, wherein removing debris from the sill cavity further comprises forcing the debris through one or more openings formed in the sill cavity into a hoistway of the elevator.

18. The method of claim 16, wherein automatically supplying air from the air supply to the at least one nozzle occurs at a predetermined interval.

19. The method of claim 16, wherein automatically supplying air from the air supply to the at least one nozzle occurs in response to a predefined event.

20. The method of claim 19, wherein automatically supplying air from the air supply to the at least one nozzle occurs in response to detection of an accumulation of debris within the sill cavity.
